(19) United States
(12) Patent Application Publication
(10) Pub. No.: US 2008/0070076 A1
(43) Pub. Date: Mar. 20, 2008

(54) FUEL CELL AND FUEL CELL SYSTEM, AND ELECTRONIC DEVICE

(75) Inventors: Kengo Makita, Kanagawa (JP); Shinichi Uesaka, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/857,763

(22) Filed: Sep. 19, 2007

(30) Foreign Application Priority Data
Sep. 19, 2006 (JP) P2006-252355

(51) Int. Cl. H01M 8/18

(52) U.S. Cl. 429/23

(57) ABSTRACT

Provided is a fuel cell capable of eliminating influence of gravity with a simple configuration and capable of obtaining a high energy density while suppressing crossover. The fuel cell in which a fuel electrode and an oxygen electrode are oppositely disposed include an electrolyte channel provided between the fuel electrode and the oxygen electrode and flowing a first fluid including an electrolyte, and a fuel channel provided on the opposite side of the oxygen electrode from the fuel electrode and flowing a second fluid including a fuel.

### CROSS REFERENCE TO RELATED APPLICATIONS

The present application claims priority to Japanese Patent Application JP 2006-252355 filed in the Japanese patent Office on Sep. 19, 2006, the entire contents of which is being incorporated herein by reference.

### BACKGROUND

The present application relates to a fuel cell such as a direct methanol fuel cell (DMFC) directly supplying methanol to a fuel electrode to make a reaction and a fuel cell system using thereof, and an electronic device.

There are energy density and output density as indexes indicating characteristics of a battery. The energy density means an amount of energy accumulation of the battery per unit mass. The output density means an amount of output of the battery per unit mass. Because a lithium ion secondary battery has two features of the relatively high energy density and the remarkably high output density at the same time, and also has high-quality perfection, it is widely selected as a power source of a mobile device. However, with the achievement of high performance of the mobile device in recent years, the electric power consumption tends to be increased and further improvement on the lithium ion secondary battery regarding the energy density and the output density is desirable.

As the measures, a change of electrode material composing a positive electrode and negative electrode, improvement on an applying method of the electrode material, and improvement on a method of enclosing the electrode material are given, and study to improve the energy density in the lithium ion secondary battery is in progress. However, the hurdle is still high for practical use. Also, unless the existing material used for the lithium ion secondary battery is changed, it is difficult to expect drastic improvement on the energy density.

Accordingly, development of a battery having the higher energy density is urgently demanded in substitution for the lithium ion secondary battery. The fuel cell is considered as prominent among the batteries having possibilities.

The fuel cell has a configuration that an electrolyte is disposed between an anode (a fuel electrode) and a cathode (an oxide electrode), and the fuel electrode is supplied with fuel and the oxygen electrode is supplied with air or oxygen, respectively. As a result, oxidation-reduction reaction occurs such that the fuel in the fuel electrode and the oxygen electrode is oxidized by the oxygen, and a part of chemical energy in the fuel is converted to electric energy to be extracted.

Various types of fuel cells have been already proposed or manufactured on a trial basis, and they partially have come into practical use. These fuel cells are classified into alkaline fuel cell (AFC), phosphoric acid fuel cell (PAFC), molten carbonate fuel cell (MCFC), solid electrolyte fuel cell (SOFC), polymer electrolyte fuel cell (PEFC), or the like according to the electrolyte used therein. In comparison with the rest of these cells, PEFC can operate in lower temperature, for example, approximately from 30° C. to 130° C.

As the fuel for the fuel cell, various flammable substances such as hydrogen and methanol can be used. However, gas fuel such as hydrogen is necessarily provided with a cylinder for storing so that it is unsuitable for size reduction. On the other hand, liquid fuel such as methanol is advantageous in point of easy storing. Especially, because DMFC is not necessarily provided with a reformer to extract hydrogen from the fuel, it has advantages that the configuration is simplified and size reduction is easily performed.

In DMFC, methanol as the fuel is generally supplied to the fuel electrode as an aqueous solution in low concentration or high concentration, or supplied as pure methanol in the gas state, and then it is oxidized to carbon dioxide in a catalyst layer of the fuel electrode. A proton generated during this process travels to the oxygen electrode through an electrolyte film separating the fuel electrode and the oxygen electrode, and it generates water by reacting with oxygen in the oxygen electrode. The reactions occurring in the fuel electrode, the oxygen electrode and the entire DMFC are expressed by Chemical formula 1.

Fuel electrode:CH₃OH+H₂O→CO₂+6e⁻+6H⁺ (Chemical formula 1)

Oxygen electrode:(3/2)O₂+6e⁻+6H⁺→3H₂O

Entire DMFC:CH₃OH+(3/2)O₂→CO₂+2H₂O

The energy density of methanol as the fuel of DMFC is theoretically 4.8 kW/L, and it is as ten times as the energy density of the usual lithium ion secondary battery. That is, the fuel cell using methanol as the fuel has a high possibility to have the energy density exceeding that of the lithium ion secondary battery. In consideration of the above, DMFC has the highest possibility to be used as the energy source of the mobile device, an electric-powered car or the like among various types of fuel cells.

However, although the theoretical voltage of DMFC is 1.23 V, there arises an issue that the output voltage is reduced to approximately 0.6 V or less when actually generating electricity. The output voltage reduction is derived from a voltage drop produced by the internal resistance of DMFC. In DMFC, there are the internal resistance such as resistance accompanied by the reaction which occurs in both of the positive and negative electrodes, resistance accompanied by a travel of a substance, resistance generated when the proton travels through the electrolyte film, further, contact resistance and the like. Because the energy that can be actually extracted as the electric energy from the oxidation of methanol is expressed by a product of the output voltage during electric generation and an amount of electricity flowing in a circuit, when the output voltage is reduced during electric generation, the amount of energy that can be actually extracted is reduced correspondingly. If the entire amount of methanol is oxidized in the fuel electrode following Chemical formula 1, the amount of electricity that can be extracted to the circuit by the oxidation of methanol is proportional to the amount of methanol in DMFC.

There also arises an issue of methanol crossover in DMFC. Methanol crossover means a phenomenon that methanol reaches to the oxygen electrode side from the fuel electrode side by a permeation of methanol through the electrolyte film, and it is caused by two mechanisms of: the phenomenon that methanol is diffusively transferred according to the difference of methanol concentration between the fuel electrode side and the oxygen electrode side; and the phenomenon of electro-osmosis such that hydrated methanol is transported by the travel of water that is brought with the travel of the proton.

When methanol crossover occurs, the permeated methanol is oxidized in the catalyst layer of the oxygen electrode. Although an oxidation reaction of methanol on the oxygen electrode side is same as that on the fuel electrode side as mentioned above, it causes the reduction of the output voltage of DMFC (for example, on page 66 of “Fuel cell systems explained” published by Ohmsha, Ltd.). Methanol is not used for the electric generation on the fuel electrode side and is wasted on the oxygen electrode side so that the amount of electricity that can be extracted to the circuit is reduced correspondingly. Further, the catalyst layer of the oxygen electrode is a catalyst of platinum (Pt), but not of platinum (Pt)-ruthenium (Ru) alloy. Thus, there occurs inconvenience such that carbon monoxide (CO) is likely adsorbed on the surface of the catalyst, resulting in catalyst poisoning.

In this way, DMFC has two issues that are the voltage reduction caused by the internal resistance and methanol crossover, and the fuel wasting by methanol crossover. These issues cause the reduction of electric generation efficiency of DMFC. In order to increase the electric generation efficiency of DMFC, the study and development to improve properties of material composing DMFC, and the study and development to optimize the operation conditions of DMFC are strenuously conducted.

As the study to improve the properties of the material composing DMFC, there is given study regarding a catalyst on the electrolyte film and the fuel electrode side. As the electrolyte film, perfluoroalkyl sulfonic acid type resin film (“Nafion (a registered trademark)” manufactured by E. I. du Pont de Nemours and Company) is generally used. However, as the electrolyte film having the higher proton conductivity and the superior property to prevent methanol from permeation compared with the perfluoroalkyl sulfonic acid type resin film, examined are fluorine type polymer film, hydrocarbons type polymer electrolyte film, hydrogel based electrolyte film, and the like. As the catalyst on the fuel electrode side, the study and development are in progress for the catalyst having the higher activity in comparison with the generally used catalyst composed of platinum (Pt)-ruthenium (Ru) alloy.

Such improvement on the properties of the material composing the fuel cell is appropriate as measures to improve the electric generation efficiency of the fuel cell. However, the suitable catalyst to solve the two abovementioned issues has not been found and the suitable electrolyte film has not been found either.

On the other hand, from page 16758 to 16759 in the 48^{th} issue of the 127^{th} volume of “Journal of the American Chemical Society” published in 2005 and in U.S. patent application publication No. 2004/0072047, these issues are not attempted to be solved by a method of the related art such as developing the electrolyte film, but proposed is a fuel cell using a laminar flow (a laminar flow fuel cell). In the laminar flow fuel cell, it is said that the issues such as flooding, liquid management, and crossover of the fuel in the oxygen electrode can be solved.

The low Reynolds number (Re) is thought of as the condition that the laminar flow occurs. The Reynolds number is a ratio of an inertia term to a viscous term, and expressed by Formula 1. Generally, when Re is less than 2000, it is said that the flow is the laminar flow.

Re=(Inertia force/Viscous force)=ρUL/μ=UL/ν (Formula 1)

where ρ is a fluid density, U is a representative velocity, L is a representative length, μ is a viscous coefficient, and ν is a kinematic viscosity.

The laminar flow fuel cell uses a micro channel. Two or more types of fluids of the laminar flow stream in the micro channel. That is, the fluids have a characteristic of the laminar flow so that the fluids flow without interminglement while forming an interface. The fuel electrode and the oxygen electrode are attached to the wall of the channel. The liquid composed of the fuel and the electrolyte solution, and water including oxygen or the liquid including only the electrolyte solution if the oxygen electrode is porous are circulated in the laminar flow; thereby the electricity can be generated successively. As understood from the above, the interface of the laminar flow functions as the electrolyte film and thus an ionic contact occurs. Therefore, the electrolyte film is unnecessary under this structure, and the issue in the fuel cell of the related art that the electric generation efficiency is reduced by the deterioration of the electrolyte film is unnecessarily taken into account.

However, the fluid flowing in the micro channel is influenced by gravity. In case two types of liquids flow, the liquid having the higher density occupies the lower part of the micro channel, and the liquid having the lower density occupies the upper part. That is, in such a structure, electric generation is enabled only when the fuel cell is disposed in the specific direction. However, it is pointless to reverse the positions of the electrodes by disposing the fuel cell up-side down or the like, because even if the positions of the electrodes are reversed, the fluids flowing in the laminar flow are certainly influenced by gravity. The positional relationship of the fluids forming the laminar flow is not changed unless the fluid density is changed. Therefore there is a high possibility that the oxygen electrode and the fluid including the fuel contact with each other.

To avoid this, U.S. patent application publication No. 2006/0088744 proposes inserting a porous separator between the fuel electrode and the oxygen electrode in the micro channel. However, because using the interface of the laminar flow as the separation film (electrolyte film) is a feature of the laminar flow fuel cell and thus the separation film is unnecessary, the existence of the porous separator is taken as serious incoherence. Also, in the laminar flow fuel cell of the related art, the factors causing the resistance come only from the resistance of the fluid and the distance between the electrodes so that inserting the porous separator becomes additional to these factors.

### SUMMARY

In view of the foregoing, it is desirable to provide a fuel cell capable of eliminating influence of gravity with the simple configuration and capable of obtaining the high energy density while suppressing crossover and a fuel cell system using thereof, and an electronic device.

The fuel cell according to an embodiment is the fuel cell in which a fuel electrode and an oxygen electrode are oppositely disposed. The fuel cell has an electrolyte channel provided between the fuel electrode and the oxygen electrode and flowing a first fluid including an electrolyte, and a fuel channel provided on the opposite side of the oxygen electrode from the fuel electrode and flowing a second fluid including a fuel.

The fuel cell system according to an embodiment has the fuel cell in which the fuel electrode and the oxygen electrode are oppositely disposed, a measurement portion measuring the operation condition of the fuel cell, and a control portion defining the operation condition of the fuel cell based on the measurement result by the measurement portion.

According to the fuel cell and the fuel cell system of an embodiment, the fuel electrode is provided between the electrolyte channel and the fuel channel so that the fuel electrode functions as a separation film separating the first fluid including the electrolyte and the second fluid including the fuel. Accordingly, although the porous separator as in the related art is not provided, the positional relationship between the first fluid and the second fluid with respect to the fuel cell is maintained; thereby the electric generation is enabled irrespective of the specific position of the fuel cell.

The fuel crossover occurs and the over voltage is generated on the oxygen electrode side when the fuel included in the second fluid necessarily passes through the fuel electrode in the unreacted state, and further, during the electric generation, the fuel necessarily passes through the first fluid including the electrolyte flowing at a constant current velocity. However, by providing the fuel electrode between the electrolyte channel and the fuel channel, almost all the fuels react when passing through the fuel electrode. Even if the fuel passes through the fuel electrode in the unreacted state, before permeating the oxygen electrode, the fuel is carried out from inside of the fuel cell by the first fluid including the electrolyte. Thus, the crossover of the fuel is remarkably suppressed. Therefore, the amount of the fuel not used for the electric generation is largely reduced so that the property of high energy density as an original advantage of the fuel cell is utilized.

The electrical device according to an embodiment is provided with the fuel cell in which the fuel electrode and the oxygen electrode are oppositely disposed, and the fuel cell thereof is composed of the abovementioned fuel cell of an embodiment.

The electrical device according to an embodiment is provided with the fuel cell having the high energy density as in an embodiment; thereby the electrical device can support the multiple functions and the high performance accompanying increase of the electric power consumption.

In the fuel cell and the fuel cell system according to an embodiment, the fuel electrode is provided between the electrolyte channel and the fuel channel so that the fuel electrode functions as the separation film separating the first fluid including the electrolyte and the second fluid including the fuel. Accordingly, although the porous separator as in the laminar flow fuel cell of the related art is not provided, the influence of gravity can be eliminated and the high energy density can be obtained while suppressing the crossover. The fuel cell and the fuel cell system have the simple and highly flexible configuration so that they can be installed in various devices from the mobile device to the large scale device. Especially, when the fuel cell and the fuel cell system are used in the electrical device having the multiple functions and the high performance that accompany the large electric power consumption, the property of the high energy density can be appropriately utilized.

Additional features and advantages are described herein, and will be apparent from, the following Detailed Description and the figures.

### BRIEF DESCRIPTION OF THE FIGURES

FIG. 1 is a view showing the schematic configuration of an electronic device provided with a fuel cell system according to a first embodiment.

FIG. 2 is a view showing the configuration of a fuel cell shown in FIG. 1.

FIG. 3 is a diagram showing the relationship between a methanol concentration and an amount of methanol crossover in a fuel electrode.

FIG. 4 is a view showing the configuration of the fuel cell according to a second embodiment.

FIG. 5 is a diagram showing a result of an example.

FIG. 6 is a diagram showing another result of the example.

FIG. 7 is a diagram showing still another result of the example.

### DETAILED DESCRIPTION

The present application will be described in further detail below according to an embodiment with reference to the drawings.

### First Embodiment

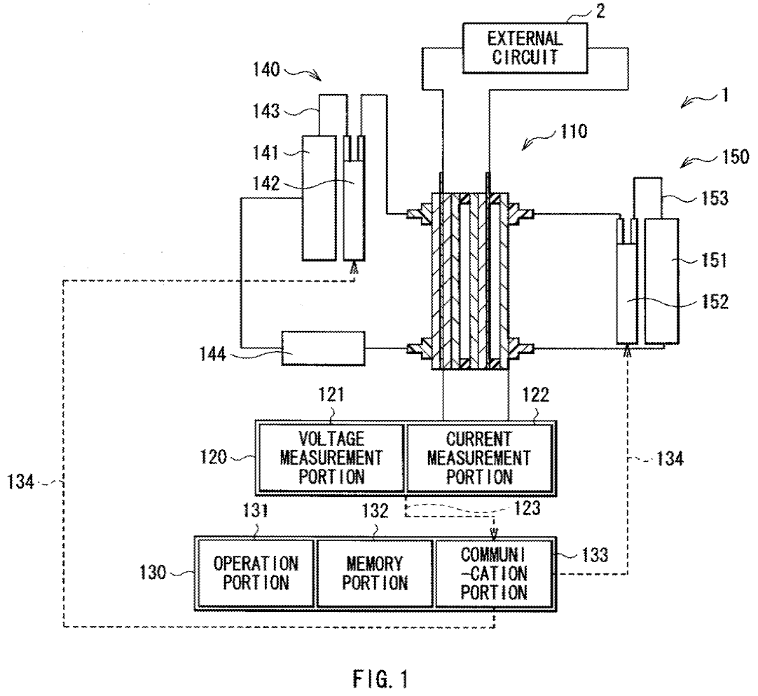

FIG. 1 shows the schematic configuration of an electronic device having a fuel cell system according to a first embodiment. This electrical device is, for example, a mobile device such as a mobile phone and a personal digital assistant (PDA), or a notebook personal computer (PC). The electrical device has a fuel cell system 1 and an external circuit (lord) 2 driven by electric energy generated in the fuel cell system 1.

The fuel cell system 1 has, for example, a fuel cell 110, a measurement portion 120 measuring the operation condition of the fuel cell 110, and a control portion 130 defining the operation condition of the fuel cell 110 based on the measurement result by the measurement portion 120. The fuel cell system 1 has, for example, an electrolyte supply portion 140 supplying sulfuric acid as a first fluid F1 including an electrolyte in the fuel cell 110. The fuel cell system 1 has, for example, a fuel supply portion 150 supplying methanol as a second fluid F2 including a fuel. By supplying the electrolyte in the form of fluid, the electrolyte film is unnecessary. Accordingly, the electric generation is enabled without the influence of temperature and moisture and the ion conductivity (proton conductivity) can be increased in comparison with the general fuel cell using the electrolyte film. Because risks such as the deterioration of the electrolyte film and the reduction of the proton conductivity caused by the dryness of the electrolyte film are eliminated, problems such as flooding and liquid management in the oxygen electrode can be solved.

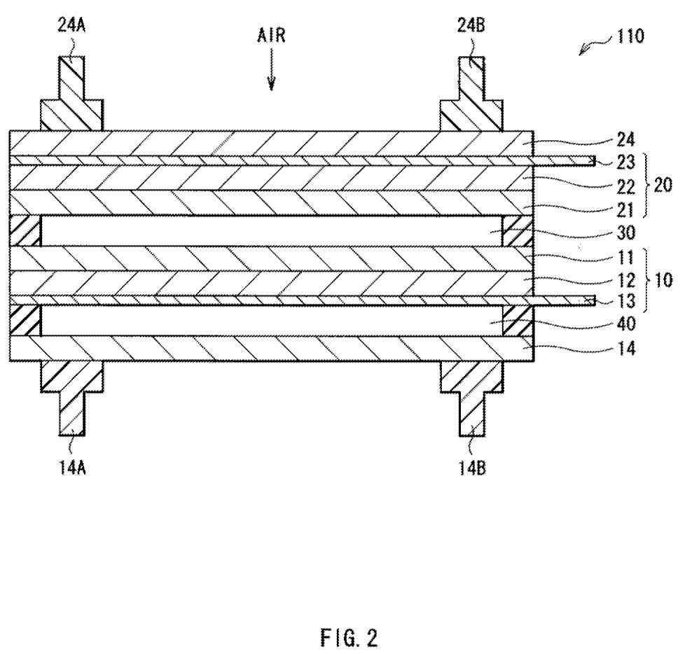

FIG. 2 shows the configuration of the fuel cell 110 shown in FIG. 1. The fuel cell 110 is a so-called direct methanol flow based fuel cell (DMFFC), and has a configuration that a fuel electrode (anode) 10 and an oxygen electrode (cathode) 20 are oppositely disposed. Between the fuel electrode 10 and the oxygen electrode 20, provided is an electrolyte channel 30 flowing the first fluid F1 including the electrolyte. On the external side of the fuel electrode 10, that is, on the opposite side of the oxygen electrode 20, provided is a fuel channel 40 flowing the second fluid F2 including the fuel. From this, in the fuel cell 110, the fuel electrode 10 functions as a separation film separating the first fluid F1 including the electrolyte and the second fluid F2 including the fuel. Therefore, the influence of gravity can be eliminated with the simple configuration and the high energy density can be obtained while suppressing the crossover.

The fuel electrode 10 has a configuration that a catalyst layer 11, a diffusion layer 12 and a current collector 13 are stacked in this order from the oxygen electrode 20 side, and is stored in an external member 14. The oxygen electrode 20 has a configuration that a catalyst layer 21, a diffusion layer 22 and a current collector 23 are stacked in this order from the fuel electrode side, and is stored in an external member 24. Air, that is, oxygen is supplied to the oxygen electrode 20 through the external member 24.

The catalyst layers 11 and 21 as catalysts are, for example, composed of simple substance such as palladium (Pd), platinum (Pt), iridium (Ir), rhodium (Rh), ruthenium (Ru) or the like, or an alloy including these. In the catalyst layers 11 and 12, a proton conductor and a binder may be included in addition to the catalysts. As the proton conductor, given is abovementioned perfluoroalkyl sulfonic acid type resin (“Nafion (a registered trademark)” manufactured by E. I. du Pont de Nemours and Company) or other resin having the proton conductivity. The binder is added to maintain the intensity and flexibility of the catalyst layers 11 and 12, and they are, for example, resin such as polytetrafluoroethylene (PTFE) and polyvinylindene fluoride (PVDF).

The diffusion layers 12 and 22 are, for example, composed of carbon cloth, carbon paper or carbon sheet. The diffusion layers 12 and 22 are preferably subjected to water repellent by polytetrafluoroethylene (PTFE) or the like.

The current collectors 13 and 23 are, for example, composed of titanium (Ti) mesh.

The external members 14 and 24 have, for example, thickness of 2.0 mm, and are composed of material such as a titanium (Ti) plate that is generally available in the market. However, the material is not specifically limited to this. The external members 14 and 24 are preferably as thin as possible in thickness.

The electrolyte channel 30 and the fuel channel 40 are, for example, fine channels formed by processing a resin sheet, and are adhered to the fuel electrode 10. A number of the channels are not limited. A width, height and length of each of the channels are not limited, but they are preferably as small as possible.

The electrolyte channel 30 is connected to the electrolyte supply portion 140 (refer to FIG. 1 as not shown in FIG. 2) through an electrolyte inlet 24A and an electrolyte outlet 24B that are provided on the external member 24, and the first fluid F1 including the electrolyte is supplied to the electrolyte channel 30 from the electrolyte supply portion 140. The fuel channel 40 is connected to the fuel supply portion 150 (refer to FIG. 1 as not shown in FIG. 2) through a fuel inlet 14A and a fuel outlet 14B provided on the external member 14, and the second fluid F2 including the fuel is supplied to the fuel channel 40 from the fuel supply portion 150.

The measurement portion 120 shown in FIG. 1 measures the operation voltage and operation current of the fuel cell 110. The measurement portion 120 has, for example, a voltage measurement circuit 121 measuring the operation voltage of the fuel cell 110, a current measurement circuit 122 measuring the operation current, and a communication line 123 transmitting the obtained measurement result to the control portion 130.

The control portion 130 shown in FIG. 1 controls an electrolyte supply parameter and a fuel supply parameter as the operation condition of the fuel cell 110 based on the measurement result from the measurement portion 120, and has, for example, an operation portion 131, a memory portion 132, a communication portion 133, and a communication line 134. Here, the electrolyte supply parameter contains, for example, a supply current velocity of the fluid F1 including the electrolyte. The fuel supply parameter contains, for example, the supply current velocity and a supply amount of the fluid F2 including the fuel, and optionally contains a supply concentration. The control portion 130 is, for example, composed of a microcomputer.

The operation portion 131 calculates the output of the fuel cell 110 from the measurement results obtained by the measurement portion 120, and sets the electrolyte supply parameter and the fuel supply parameter. Specifically, the operation portion 131 has functions of: averaging anode electric potential, cathode electric potential, output voltage, and output current sampled at a regular time interval from various measurement results inputted in the memory portion 132; calculating the average anode electric potential, the average cathode electric potential, the average output voltage and the average output current; inputting the resultant into the memory portion 132; and comparing the various average values with each other that are stored in the memory portion 132 in order to judge the electrolyte supply parameter and the fuel supply parameter.

The memory portion 132 memorizes the various measurement values transmitted from the measurement portion 120 and the various average values calculated by the operation portion 131.

The communication portion 133 has functions of receiving the measurement results from the measurement portion 120 through the communication line 123, and inputting the resultant into the memory portion 132. The communication portion 133 also has a function of outputting signals to set the electrolyte supply parameter and the fuel supply parameter respectively into the electrolyte supply portion 140 and the fuel supply portion 150 through the communication line 134.

The electrolyte supply portion 140 shown in FIG. 1 has an electrolyte storage portion 141, an electrolyte supply adjustment portion 142, an electrolyte supply line 143 and a separation room 144. The electrolyte storage portion 141 stores the first fluid F1 including the electrolyte, and is, for example, composed of a tank or a cartridge. The electrolyte supply adjustment portion 142 adjusts the supply current velocity of the first fluid F1 including the electrolyte. The electrolyte supply adjustment portion 142 may be composed of anything that can be driven by a signal from the control portion 130. It is not specifically limited, but the electrolyte supply adjustment portion 142 is, for example, preferably composed of a bulb or an electromagnetic pump driven by a motor or a piezoelectric device. Because there is a possibility that a small amount of methanol is mixed with the first fluid F1 including the electrolyte coming from the electrolyte outlet 24B, the separation room 144 is for separating off of methanol. The separation room 144 is provided in the vicinity of the electrolyte outlet 24B, and has a function of eliminating a filter or methanol by burning, reaction or evaporation as a separation mechanism of methanol.

The fuel supply portion 150 shown in FIG. 1 has a fuel storage portion 151, a fuel supply adjustment portion 152, and a fuel supply line 153. The fuel storage portion 151 stores the second fluid F2 including the fuel, and is, for example, composed of a tank or a cartridge. The fuel supply adjustment portion 152 adjusts the supply current velocity and the supply amount of the second fluid F2 including the fuel. The fuel supply adjustment portion 152 may be composed of anything that can be driven by a signal from the control section 130. It is not specifically limited, but the fuel supply adjustment portion 152 is, for example, preferably composed of a bulb or an electromagnetic pump driven by a motor or piezoelectric device. The fuel supply portion 150 may have a concentration adjustment portion (not shown in the figure) adjusting the supply concentration of the second fluid F2 including the fuel. When pure (99.9%) methanol is used as the second fluid F2 including the fuel, the concentration adjustment portion may be omitted, and the fuel supply portion 150 can be reduced in size.

The fuel cell system 1 can, for example, be manufactured in the following way.

An alloy including, for example, platinum (Pt) and ruthenium (Ru) as catalysts at a predetermined rate and a dispersion solution of perfluoroalkyl sulfonic acid type resin (“Nafion (a registered trademark)” manufactured by E. I. du Pont de Nemours and Company) are mixed at the predetermined rate in order to form the catalyst layer 11 of the fuel electrode 10. The catalyst layer 11 is bonded by thermal compression to the diffusion layer 12 of the abovementioned material. Further, the current collector 13 of the abovementioned material is bonded by thermal compression using a hot-melt type adhesive or an adhesive resin sheet in order to form the fuel electrode 10.

A carbon supporting platinum (Pt) as a catalyst and the dispersion solution of perfluoroalkyl sulfonic acid type resin (“Nafion (a registered trademark)” manufactured by E. I. du Pont de Nemours and Company) are mixed at the predetermined rate in order to form the catalyst layer 21 of the oxygen electrode 20. The catalyst layer 21 is bonded by thermal compression to the diffusion layer 22 of the abovementioned material. Further, the current collector 23 of the abovementioned material is bonded by thermal compression using the hot-melt type adhesive or the adhesive resin sheet in order to form the oxygen electrode 20.

The adhesive resin sheet is prepared. Channels are formed on this resin sheet in order to make the electrolyte channel 30 and fuel channel 40, and the electrolyte channel 30 and the fuel channel 40 are bonded by thermal compression to both sides of the fuel electrode 10.

The external members 14 and 24 of the abovementioned material are manufactured. The external member 14 is provided with the fuel inlet 14A and the fuel outlet 14B composed of, for example, joints of resin, and the external member 24 is provided with the electrolyte inlet 24A and the electrolyte outlet 24B composed of, for example, joints of resin.

While externally placing the fuel channel 40, the fuel electrode 10 and the oxygen electrode 20 are oppositely disposed with the electrolyte channel 30 in between, and enclosed in the external members 14 and 24. Thereby, the fuel cell 110 shown in FIG. 2 is completed.

This fuel cell 110 is installed in the system having the measurement portion 120, the control portion 130, the electrolyte supply portion 140 and the fuel supply portion 150 of the abovementioned configuration. The fuel inlet 14A and the fuel outlet 14B, and the fuel supply portion 150 are connected to the fuel supply line 153 composed of, for example, a silicon tube. The electrolyte inlet 24A and the electrolyte outlet 24B, and the electrolyte supply portion 140 are connected to the electrolyte supply line 143 composed of, for example, a silicon tube. Thereby, the fuel cell system 1 shown in FIG. 1 is completed.

In this fuel cell system 1, the second fluid F2 including the fuel is supplied to the fuel electrode 10 and the resulting reaction produces the proton and the electron. The proton travels to the oxygen electrode 20 through the first fluid F1 including the electrolyte, and produces water in reaction with the electron and the oxygen. The reactions occurring in the fuel electrode 10, the oxygen electrode 20 and the entire fuel cell 110 are expressed by Chemical formula 2. Thereby, a part of chemical energy of methanol as the fuel is converted to electric energy so that the current is extracted from the fuel cell 110 and the external circuit 2 is driven. The carbon dioxide produced in the fuel electrode 10 and the water produced in the oxygen electrode 20 are removed while they flow with the first fluid F1 including the electrolyte.

Fuel electrode 10:CH₃OH+H₂O→CO₂+6e⁻+6H⁺ (Chemical formula 2)

Oxygen electrode 20:(3/2)O₂+6e⁻+6H⁺→3H₂O

Entire fuel cell 110:CH₃OH+(3/2)O₂→CO₂+2H₂O

During the operation of the fuel cell 110, the measurement portion 120 measures the operation voltage and the operation current of the fuel cell 110. Based on the measurement result, by the control portion 130, the electrolyte supply parameter and the fuel supply parameter mentioned above are controlled as the operation condition of the fuel cell 110. The measurement by the measurement portion 120 and the parameter control by the control portion 130 are frequently repeated so that, following the property change of the fuel cell 110, the supply conditions of the first fluid F1 including the electrolyte and the second fluid F2 including the fuel are optimized.

Here, because the fuel electrode 10 is provided between the electrolyte channel 40 and the fuel channel 30, the fuel electrode 10 functions as the separation film separating the first fluid F1 including the electrolyte and the second fluid F2 including the fuel. Therefore, although the porous separator as in the laminar flow fuel cell of the related art is not provided, the positional relationship between the first fluid F1 and the second fluid F2 with respect to the fuel electrode 10 is maintained; thereby the electric generation is enabled irrespective of the specific position of the fuel cell 110.

The fuel crossover occurs and the over voltage is generated on the oxygen electrode 20 side when the fuel included in the second fluid F2 necessarily passes through fine pores of the fuel electrode 10 in the unreacted state, and further, during the electric generation, the fuel necessarily passes through the first fluid F1 including the electrolyte flowing at a constant current velocity. However, by providing the fuel electrode 10 between the electrolyte channel 40 and the fuel channel 30, almost all the fuels react when passing through the fine pores of the fuel electrode 10. Even if the fuel passes through the fuel electrode 10 in the unreacted state, before permeating the oxygen electrode 20, the fuel is carried out from inside of the fuel cell 110 by the first fluid F1 including the electrolyte. Thus, the crossover of the fuel is remarkably suppressed. Therefore, the amount of the fuel not used for the electric generation is largely reduced so that the property of high energy density as an original advantage of the fuel cell is utilized.

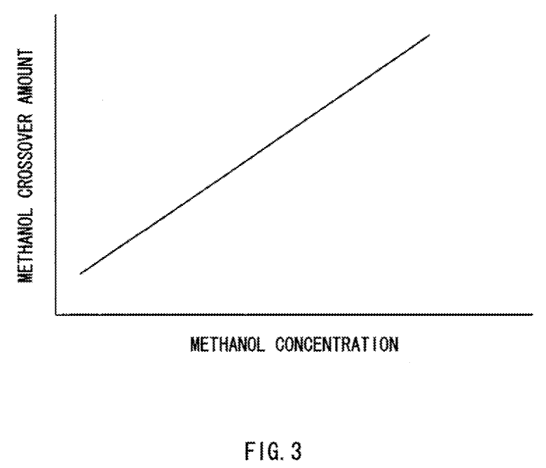

On the other hand, when the fuel cell using the electrolyte film of the related art and the laminar flow fuel cell of the related art use the highly concentrated methanol water solution or pure methanol as the fuel in order to utilize the high energy density as the feature of the fuel cell, the methanol concentration in the fuel electrode is increased too high. As shown in FIG. 3, as the methanol concentration in the fuel electrode is increased, the amount of methanol crossover is increased. Therefore, the electric generation property of the related art is largely reduced by the fuel wasting caused by increase of the crossover, and the reduction of the output voltage.

According to the present embodiment, because the fuel electrode 10 is provided between the electrolyte channel 30 and the fuel channel 40, the fuel electrode 10 functions as the separation film separating the first fluid F1 including the electrolyte and the second fluid F2 including the fuel.

Although the porous separator as in the laminar flow fuel cell of the related art is not provided, the influence of gravity can be eliminated and the high energy density can be obtained while suppressing the crossover. Because of its simple and highly flexible configuration, the fuel cell can be installed in various devices from the mobile device to the large scale device. Especially, when the fuel cell is used in the electrical device having multiple functions and high performance, the property of the high energy density can be appropriately utilized.

### Second Embodiment

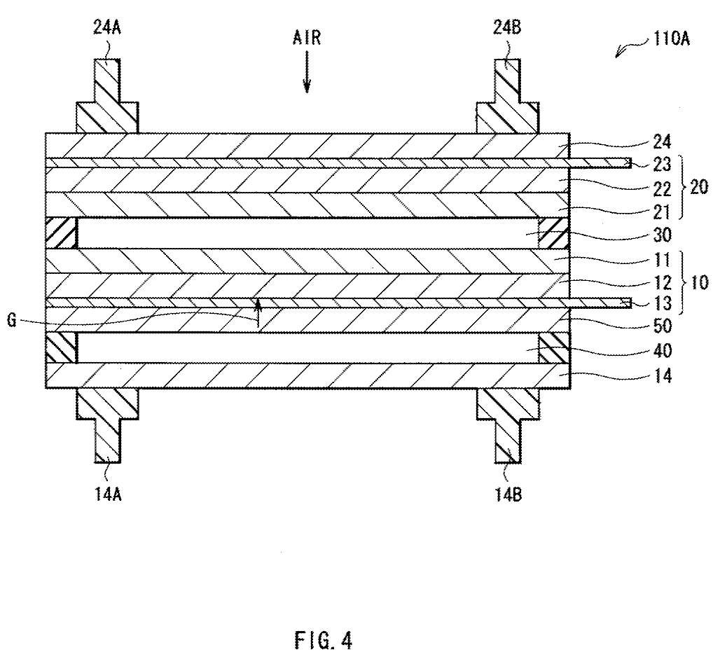

FIG. 4 shows the configuration of a fuel cell 110A according to a second embodiment. This fuel cell 110A has a similar configuration to the fuel cell 110 described in the first embodiment except that a gas-liquid separation film 50 is provided between a fuel electrode 40 and a fuel electrode 10. Thereby same reference numerals as in the first embodiment are used to indicate substantially identical components.

The gas-liquid separation film 50 can be composed, for example, of a film unpermeable of alcohol in the liquid state such as polytetrafluoroethylene (PTFE), polyvinylindene fluoride (PVDF), and polypropylene (PP).

This fuel cell 110A and a fuel cell system 1 using the fuel cell 110A can be manufactured in the same way as the first embodiment except that the gas-liquid separation film 50 is provided between the fuel channel 40 and the fuel electrode 10.

In the fuel cell system 1, the current is extracted from the fuel cell 110A and an external circuit 2 is driven in the same way as the first embodiment. Here, the gas-liquid separation film 50 is provided between the fuel channel 40 and the fuel electrode 10 so that the pure methanol in the liquid state as the fuel spontaneously vaporizes when passing through the fuel channel 40. Then, the resultant in the state of a gas G passes through the gas-liquid separation film 50 from the face adjacent to the gas-liquid film 50, and is supplied to the fuel electrode 10. Thus, the fuel is supplied efficiently to the fuel electrode 10 and the reaction is performed stably. Because the fuel in the gas state is supplied to the fuel electrode 10, the electrode reaction activity is enhanced and the crossover hardly occurs. Therefore, the high performance can be also obtained in an external circuit 2 having high lord.

Even if methanol in the gas state passing through the fuel electrode 10 exists, it is removed by a first fluid F1 including the electrolyte before reaching to the oxygen electrode 20 in the same way as the first embodiment.

According to the second embodiment, the gas-liquid separation film 50 is provided between the fuel channel 40 and the fuel electrode 10 so that pure (99.99%) methanol can be used as a second fluid F2 including the fuel and the property of the high energy density as the feature of the fuel cell can be further utilized. Also, the stability of the reaction and the electrolyte reaction activity can be enhanced while suppressing the crossover. Thus, the high performance can also be obtained in an electrical device having the external circuit 2 of high lord. Further, in a fuel supply portion 150, a concentration adjustment portion adjusting the supply concentration of the second fluid F2 including the fuel can be omitted; thereby size reduction is enabled.

### EXAMPLE

Further, a specific example of the present application will be described. In the below example, a fuel cell 110A having a similar configuration to FIG. 4 was manufactured, and the properties were evaluated. Therefore, same reference numerals were used with reference to FIGS. 1 and 4.

The fuel cell 110A having a similar configuration to FIG. 4 was manufactured. An alloy including platinum (Pt) and ruthenium (Ru) at a predetermined rate as a catalyst and a dispersion solution of perfluoroalkyl sulfonic acid type resin (“Nafion (a registered trademark)” manufactured by E. I. du Pont de Nemours and Company) were mixed at the predetermined rate in order to form a catalyst layer 11 of a fuel electrode 10. The catalyst layer 11 was bonded by thermal compression to a diffusion layer 12 (HT-2500 manufactured by E-TEK Inc.) of the abovementioned material for 10 minutes under the conditions where the temperature was 150° C. and the pressure was 249 kPa. Further, a current collector 13 of the abovementioned material was bonded by thermal compression using a hot-melt type adhesive or an adhesive resin sheet in order to form the fuel electrode 10.

A carbon supporting platinum (Pt) as a catalyst and a dispersion solution of perfluoroalkyl sulfonic acid type resin (“Nafion (a registered trademark)” manufactured by E. I. du Pont de Nemours and Company) were mixed at the predetermined rate in order to form a catalyst layer 21 of an oxygen electrode 20. The catalyst layer 21 was bonded by thermal compression to the diffusion layer 22 (HT-2500 manufactured by E-TEK Inc.) of the abovementioned material in the same way as the catalyst layer 11 of the fuel electrode 10. Further, the current collector 23 of the abovementioned material was bonded by thermal compression in the same way as the current collector 13 of the fuel electrode 10 in order to form the oxygen electrode 20.

Next, the adhesive resin sheet was prepared. Channels were formed on the resin sheet in order to form an electrolyte channel 30 and a fuel channel 40, and they were bonded by thermal compression to both sides of the fuel electrode 10.

Next, the external members 14 and 24 of the abovementioned material were manufactured. The external member 14 was provided with a fuel inlet 14A and fuel outlet 14B composed of, for example, joints of resin and the external member 24 was provided with an electrolyte inlet 24A and an electrolyte outlet 24B composed of, for example, joints of resin.

While externally placing the fuel channel 40, the fuel electrode 10 and the oxygen electrode 20 were oppositely disposed with the electrolyte channel 30 in between and the fuel electrode 10 and the oxygen electrode 20 were stored in the external members 14 and 24. At this time, a gas-liquid separation film 50 (manufactured by Millipore Corporation) was provided between the fuel channel 40 and fuel electrode 10; thereby the fuel cell 110A was completed as shown in FIG. 4.

This fuel cell 110A was installed in a system having a measurement portion 120, a control portion 130, an electrolyte supply portion 140 and a fuel supply portion 150 of the abovementioned configuration; thereby the fuel cell system 1 was configured as shown in FIG. 1. At that time, an electrolyte supply adjustment portion 142 and a fuel supply adjustment portion 152 were composed of diaphragm type quantitative pumps (manufactured by KNF Neuberger GmbH). One of the pumps was directly connected to the fuel inlet 14A by the electrolyte supply line 143, and the other of the pumps was directly connected to the electrolyte inlet 24A by the fuel supply line 153. Thus the first fluid F1 including the electrolyte was supplied to the electrolyte channel 30 and the second fluid F2 including the fuel was supplied the fuel channel 40 at the arbitral current velocity, respectively. As the first fluid F1 including the electrolyte, 0.5 M sulfuric acid was used, and the current velocity was 1.0 ml/min. As the second fluid F2 including the fuel, pure (99.99%) methanol was used, and the current velocity was 0.80 ml/min.

(Evaluation)

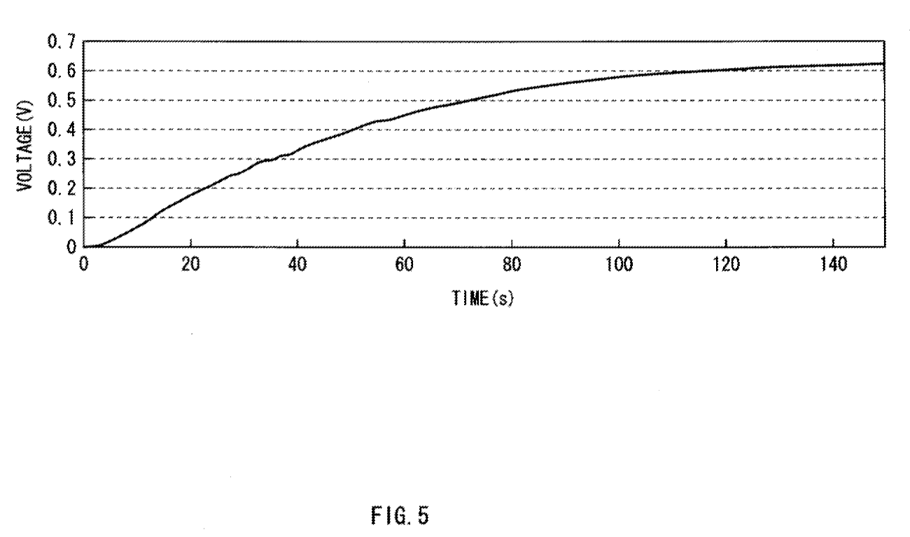

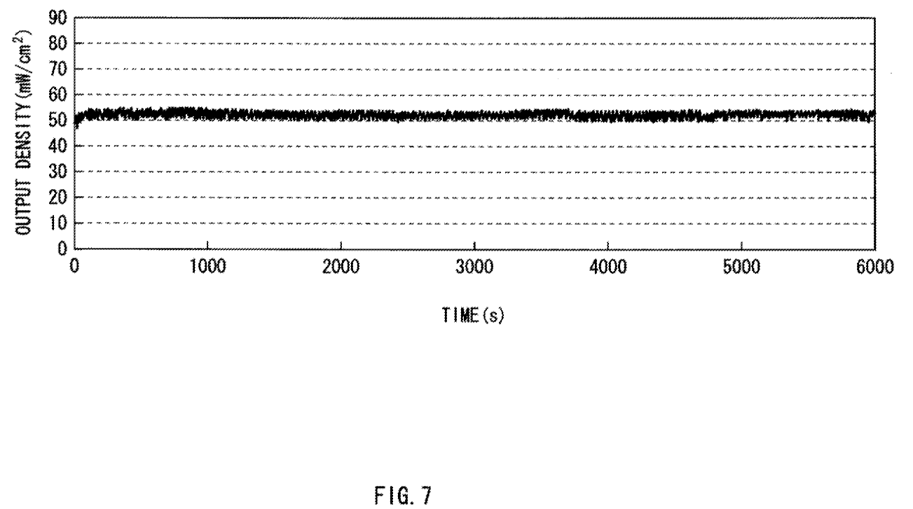

The obtained fuel cell system 1 was connected to an electrochemical measurement system (Multistat 1480 manufactured by Solartoron Co., Ltd) and the properties of the fuel cell system 1 were evaluated. The operation of the constant current (20 mA, 50 mA, 100 mA, 150 mA, 200 mA, and 250 mA) mode was executed, and open circuit voltage (OCV) in the initial state of the measurement, the properties of current-voltage (I-V) and current-power (I-P), and the output density when generating electric power with the current density of 150 mA/cm² were examined. The results are shown in FIGS. 5 and 7.

FIG. 5 shows OCV in the initial state of the measurement. OCV is maintained for approximately 150 seconds and is highly stable. FIG. 5 shows OCV of a remarkably high value (0.62 V) in comparison with OCV of the usual DMFC (approximately 0.4 V to 0.5 V). It was thinkable that this was because the fuel crossover was suppressed by using the fluid F1 including the electrolyte. The laminar flow fuel cell was used for the same measurement, and it was unfunctionable as a cell by showing OCV of 0 V or less. When the fuel cell 110A of the present example was disposed in a reverse position, it was confirmed that the electric generation was still enabled in the reverse position.

That means, if the fuel cell 10 was provided between the electrolyte channel 30 and the fuel channel 40, and the gas-liquid separation film 50 was provided between the fuel channel 40 and the fuel electrode 10, OCV higher than that of DMFC in the related art could be obtained without the crossover although 100% sulfuric acid was used as the fluid F1 including the electrolyte.

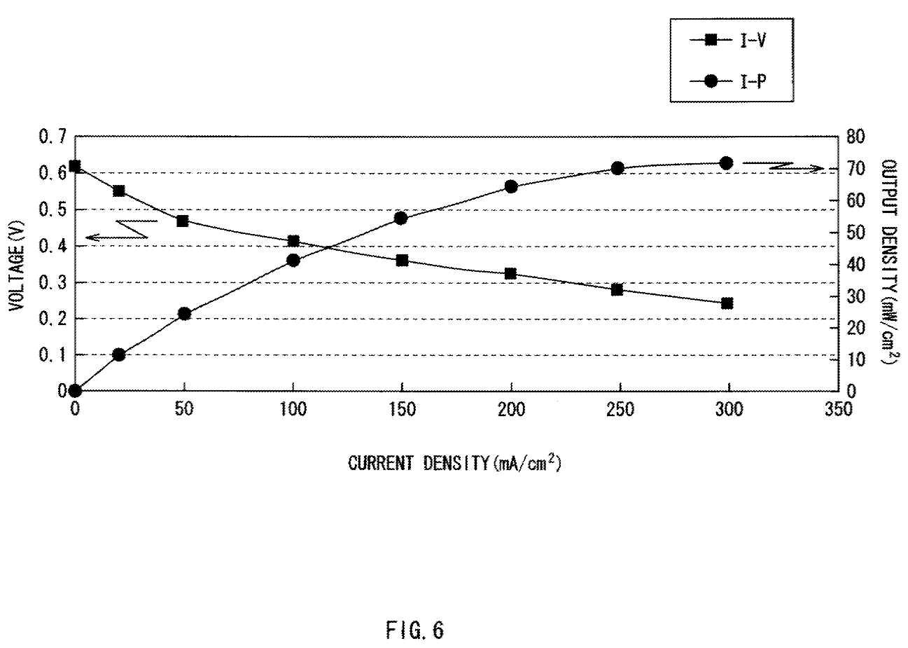

As understood from FIG. 6, the properties of the fuel cell 110A of the present example were highly favorable, and the electric power density of 75 mW/cm² was obtained. Further, as understood from FIG. 7, when the electric power was generated with the current density of 150 mA/cm², the electric generation was enabled stably for 6000 seconds or more. That is, it was confirmed that when the fuel electrode 10 was provided between the electrolyte channel 30 and the fuel channel 40, and the gas-liquid separation film 50 was provided between the fuel channel 40 and the fuel electrode 10, the fuel cell could properly operated.

The present application as described herein should not be limited to such description where modifications thereof should be considered. For example, in the embodiments and example, the configurations of the fuel electrode 10, the oxygen electrode 20, the fuel channel 30 and the electrolyte channel 40 are specifically described, but other configuration or the configuration of other material may be described. For example, it is described in the embodiments and example that the fuel channel 30 is formed by processing the resin sheet and forming channels. However, the fuel channel 30 may be composed of a porous sheet or the like.

Also, it is described that the second fluid F2 including the fuel is composed by methanol, but it may be composed of other alcohol such as ethanol and dimethyl ether. The first fluid F1 including the electrolyte can be unlimitedly composed, as long as it is composed of material having proton (H⁺) conductivity, for example, such as sulfuric acid, phosphoric acid, and ionic liquid.

Further, for example, the material of each component and the thickness, and the operation condition of the fuel cell 110 are not limited as described in the embodiments and the example. Different material and different thickness, and different operation conditions may be used.

In the embodiments and the example, the fuel is supplied from the fuel supply portion 150 to the fuel electrode 10. However, the fuel electrode 10 may be a closed type and the fuel may be optionally supplied.

In the embodiments and the example, air is supplied to the oxygen electrode 20 by the spontaneous ventilation. However, air may be forcedly supplied by using a pump or the like. In this case, oxygen or gas including oxygen may be supplied instead of air.

The present application is not limited to DMFC, but applicable to other types of fuel cell such as a fuel cell using hydrogen (PEFC or an alkaline fuel cell) as fuel.

In the embodiments and the example, the single cell type fuel cell is described, but the present application is also applicable to a stacked type fuel cell with a plurality of fuel cells in a stacked configuration.

In the embodiments and example, the case is explained where the present application is applied to the fuel cell and the fuel cell system, and the electrical device provided therewith. However, besides the fuel cell, the present application is also applicable to other electrochemical device such as a capacitor, a fuel sensor, or a display.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A fuel cell in which a fuel electrode and an oxygen electrode are oppositely disposed, comprising:
an electrolyte channel provided between the fuel electrode and the oxygen electrode and flowing a first fluid including an electrolyte; and
a fuel channel provided on the opposite side of the oxygen electrode from the fuel electrode and flowing a second fluid including a fuel.

2. The fuel cell according to claim 1 comprising:
a gas-liquid separation film provided between the fuel channel and the fuel electrode.

3. A fuel cell system comprising:
a fuel cell in which a fuel electrode and an oxygen electrode are oppositely disposed;
a measurement portion measuring the operation condition of the fuel cell; and
a control portion defining the operation condition of the fuel cell based on a measurement result by the measurement portion,
wherein the fuel cell has an electrolyte channel provided between the fuel electrode and the oxygen electrode and flowing a first fluid including an electrolyte, and
a fuel channel provided on the opposite side of the oxygen electrode from the fuel electrode and flowing a second fluid including a fuel.

4. An electronic device provided with a fuel cell in which a fuel electrode and an oxygen electrode are oppositely disposed,
wherein the fuel cell includes an electrolyte channel provided between the fuel electrode and the oxygen electrode and flowing a first fluid including an electrolyte, and
a fuel channel provided on the opposite side of the oxygen electrode from the fuel electrode and flowing a second fluid including a fuel.
